(19) United States
(12) Patent Application Publication
(10) Pub. No.: US 2011/0203170 A1
(43) Pub. Date: Aug. 25, 2011

(54) Process and system for producing sterilized shredded material and resulting shredded material

(76) Inventor: Joseph P. Quaranta, Roxbury, CT (US)

(21) Appl. No.: 12/932,444

(22) Filed: Feb. 24, 2011

Related U.S. Application Data
(60) Provisional application No. 61/338,909, filed on Feb. 24, 2010.

(51) Int. Cl. A01G 1/00

(52) U.S. Cl. 47/9; 241/15; 241/29; 241/23; 241/38; 241/65

(57) ABSTRACT

A process and system for producing sterilized shredded material such as mulch or compost introduces a sterilant during a grinder stage for forming the shredded material, wherein the sterilant is presented by introduction with water via a spray bar at the grinder stage. The grinder stage may have a preliminary first (initial) grinder stage. The process may include shearing wood parts to a uniform size prior to the first grinder stage. The resulting shredded material can be irradiated or subjected to external heat. Testing of the resulting output shredded material can be conducted to determine the presence of mold spores, or the like and, if found, for redirecting the shredded material to the grinder stage associated with the sterilant.

### CROSS REFERENCE TO RELATED APPLICATION

This application claims priority under 35 USC §119 to U.S. Provisional Patent Application No. 61/338,909 filed on Feb. 24, 2010.

### TECHNICAL FIELD

The present invention relates to a process and system for producing sterilized shredded material such as mulch and landscape compost.

### BACKGROUND OF THE INVENTION

Shredded material, such as organic mulch and landscape composts have been used for years to provide protective cover for landscaping and the like, while landscape compost can further be used for enriching soil and the like. In the past, it has not been realized that there may be mold spores, fungi, and disease carrying bacteria and viruses in the resulting mulch or landscape compost.

### SUMMARY OF THE INVENTION

The present invention is directed to a process and system for producing sterilized shredded material, including mulch and landscape compost that greatly reduces or totally eliminates fungus, mold spores, and diseases which may be present in such shredded material as compared to shredded material produced with methods according to the state of the art.

In particular, the present invention produces an essentially sterilized shredded material, such as mulch and/or landscape compost by introducing a sterilant during the process steps for producing the shredded material which effectively kills mold spores, fungus, and/or other diseases that may be present in the shredded material.

In a preferred embodiment, the sterilant is hydrogen peroxide (H₂O₂) at a 3% concentration. Other sterilants and/or processes may be used instead of hydrogen peroxide as discussed below.

A system for performing the process is also disclosed.

### BRIEF DESCRIPTION OF THE PHOTOGRAPHS

For a better understanding of the nature and objects of the present invention, reference is made to the following detailed description taken in conjunction with the following figures and photographs.

FIG. 1 is an overall flowchart showing the stages (steps) for producing a sterilized shredded material, such as mulch and landscape compose essentially free of fungus, mold spores, and disease-bearing material.

FIG. 2 is a block diagram of a system for performing the process shown in FIG. 1.

### DETAILED DESCRIPTION

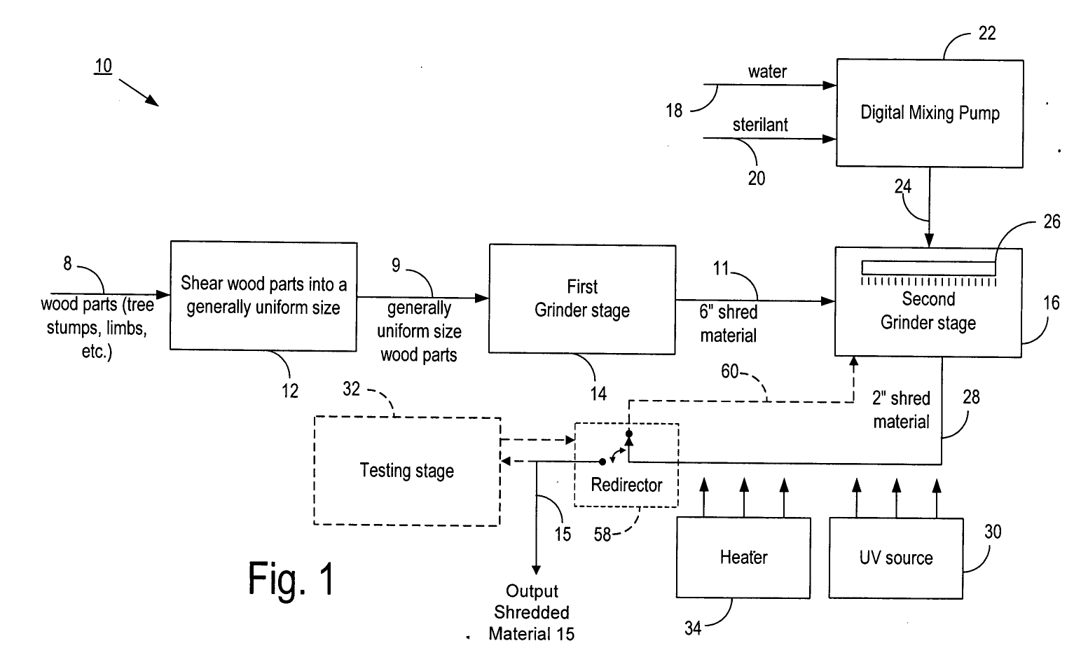

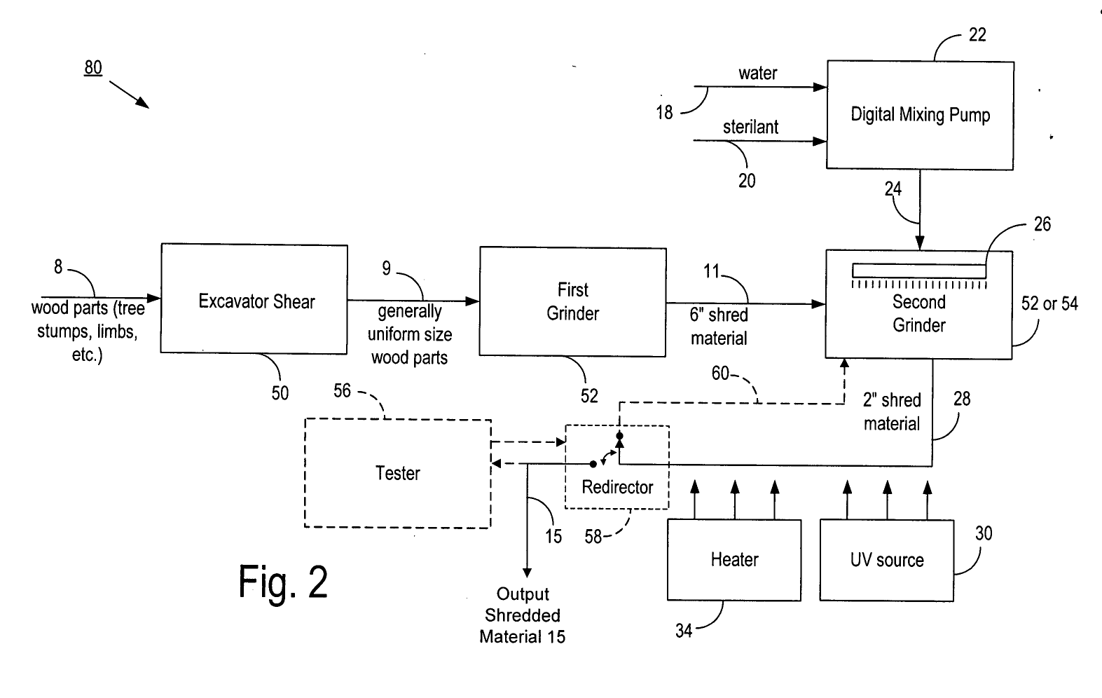

As seen in FIGS. 1 and 2, the present invention is directed to a process 10 for producing shredded material, such as mulch and landscape compost which is sterilized and essentially free from mold spores, fungus, and diseases. The overall system 80 is shown in FIG. 2.

In an embodiment of the present invention, the process begins by taking various wood parts 8, such as tree stumps, limbs, and the like and shearing (step 12) the wood parts to a generally uniform size output 9. This is performed with an excavator shear 50 as seen in FIG. 2, which is typically attached to an excavator (not shown). The uniform size of these pieces at output 9 can be up to several feet in length with the output 9 from the shearing stage 12 proceeding to a first grinder stage 14. In this first grinder stage, the generally uniform size wood parts are ground by a grinder 52 (see FIG. 2), to what is known in the art as 6″ minus 11, meaning that the shredded material has a length no greater than six inches. The first grinder stage uses a 6 inch screen size on grinder 52 to maintain the 6″ minus output 11 of shredded material. After the first grinder stage 14, the shredded material is presented to a second grinder stage 16 for further grinding by grinder 52 or additional grinder 54. The output 28 of the second grinder stage is 2″ minus shredded material; that is shredded material having a length no greater than two inches. It is at this stage that sterilization of the shredded material is performed. As noted above, the same grinder 52 as used in stage 12 or a second grinder 54 can be used at stage 16, but using a 2 inch screen size rather than a 6 inch screen size. Other screen sizes for the first and second grinder stages can also be used depending upon the desired final size of the shredded material. Although two grinder stages are shown, fewer or greater grinder stages can be used depending on the size of the incoming wood parts after shearing and the desired maximum output size of shredded material.

In a preferred embodiment, water 18 and sterilant 20 are presented to a digital mixing pump 22 with the resulting mixture/solution output material 24 is presented to grinder stage 16 via a spray bar 26. The spray bar provides a uniform application of the diluted sterilant to the shredded material as the shredded material is being ground to the 2″ minus size.

In an embodiment of the present invention, the sterilant is a 3% by weight solution concentration of hydrogen peroxide (H₂O₂) in water which is mixed with high pressure water in the digital mixing pump for presentation to spray bar 26. Other solution concentrations of hydrogen peroxide or other oxidizing agents can be used as discussed below.

The resulting 2″ minus shredded material 28 is then essentially free from mold spores, fungus, and disease bearing material.

It should be noted that the digital mixing pump stage 22 may additionally add colorant to the spray mixture/solution for purposes of coloring the mulch as it is being further shredded in the grinder stage 16.

It has been found that the shredding and grinder stages are effective in essentially killing insect larvae and eggs, including those associated with the Asian Longhorn Beetle. However, the sterilization of the shredded material is effective in killing disease-bearing viruses, bacteria, and the like, such as those associated with Dutch Elm disease.

In addition to the use of hydrogen peroxide, other sterilant materials can be used, including vinegar and bleach (1 to 3 parts per million), as well as the use of ozone (O₃) as a gaseous introduction to the liquid sprayed from spray bar 26.

Furthermore, shredded material 28 can also be irradiated with ultraviolet light from an ultraviolet light source 30 as it exits the second grinder stage to enhance sterilization.

Typically, the resulting output shredded material 15 is placed in piles (not shown). In such piles, after standing for several days, the heat generated as a result of decomposition of the shredded material generates internal temperatures within the pile of typically 100-150° C. which also is effective for killing fungus, mold spores, and disease-bearing materials, at least for those portions of the mulch in the interior of the pile. However, the present invention is able to provide a substantially sterilized resulting mulch prior to storing the material in a pile and insures that all of the material is effectively sterilized and not just material in the interior of a pile of shredded material after being stored for typically 7-30 days in such a pile.

Furthermore, in place of or in addition to an ultraviolet light source 30, heat from heater 34 can be directly applied to the exiting shredded material so as to heat the shredded material to 100-150° C.

In an embodiment, a testing stage 32 as performed by a tester 56 can optionally be used for testing some or all of the exiting shredded material 15 to examine for the presence of any mold spores, disease-bearing material or the like and, if detected, to cause redirector 58 to re-direct (see path 60) the shredded material to the second grinder stage 16 (grinder 52 or 54—see FIG. 2) for application of additional sterilant. Alternatively, the material can be presented for additional irradiation from the ultraviolet light source 30 or additional heating by heater 34.

It is therefore apparent that the resulting output shredded material 15 has the desired size, such as 2″ minus and which additionally not only is essentially free from larvae and insects as a result of the grinding stages, but also is essentially free from mold spores, fungus, and disease carrying elements as a result of the application of sterilant and/or sterilizing irradiation and/or heat as discussed above.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

Having described the invention, what is claimed is:

1. A process for producing sterilized organic shredded material comprising:
grinding incoming shredded material and introducing a sterilant during said grinding so as to generate an output shredded material of smaller size than said incoming shredded material, that is substantially free from mold spores and disease carrying material.

2. The process of claim 1, wherein the sterilant is hydrogen peroxide.

3. The process of claim 2, wherein the hydrogen peroxide has a concentration of approximately 3% by weight in water.

4. The process of claim 3, wherein the sterilant is diluted with the introduction of water in a mixing pump and is applied during the grinding stage by a spray bar.

5. The process of claim 2, further preliminarily comprising grinding the incoming shredded material in two grinder stages.

6. The process of claim 5, further preliminarily including receiving wood parts and shearing the wood parts into a generally uniform size so as to form said incoming shredded material.

7. The process of claim 6, further comprising irradiating with ultraviolet light the shredded material after introduction of said sterilant.

8. The process of claim 7 further comprising testing the output shredded material to determine the presence of mold spores or disease carrying material and, if detected, for re-irradiating the shredded material.

9. The process of claim 1, further comprising testing the output shredded material to determine the presence of mold spores or disease carrying material and, if detected, for re-directing the shredded material back to the grinding step for the introduction of additional sterilant.

10. The process of claim 1, wherein the output shredded material is subjected to an external heat source for raising the temperature of the output shredded material to between approximately 100-150° C.

11. The process of claim 1, further preliminarily comprising initially grinding wood parts so as to produce said incoming shredded material.

12. The process of claim 1, further comprising irradiating with ultraviolet light the shredded material after introduction of said sterilant.

13. A shredded material produced according to the method of claim 1.

14. A system for sterilizing organic shredded material comprising:
a grinder configured to grind incoming shredded material; and
a pump configured to introduce sterilant to the grinder as the incoming shredded material is further ground by the grinder so as to generate an output shredded material of smaller size than said incoming shredded material that is substantially free from mold spores and disease carrying material.

15. The system of claim 14, wherein the sterilant is hydrogen peroxide.

16. The system of claim 14, further comprising a spray bar configured to receive the sterilant from the pump and further configured to apply the sterilant to the grinder during grinding of the incoming shredded material.

17. The system of claim 14, further comprising a first grinder so as to produce said incoming shredded material.

18. The system of claim 17, further comprising an excavator shear configured to receive wood parts and to shear the wood parts into a generally uniform size for presentation to said first grinder.

19. The system of claim 18, further comprising an ultraviolet source configured to irradiate with ultraviolet light the output shredded material after introduction of said sterilant.

20. The system of claim 19, further comprising a tester and a redirector, the tester configured to test the output shredded material to determine the presence of mold spores or disease carrying material and, if detected, to cause the redirector to redirect the output shredded material back to the grinder associated with the pump so as to introduce additional sterilant to the shredded material.
